(19) United States
(12) Patent Application Publication
(10) Pub. No.: US 2023/0046465 A1
(43) Pub. Date: Feb. 16, 2023

(54) HOLISTIC CAMERA CALIBRATION SYSTEM FROM SPARSE OPTICAL FLOW

(71) Applicant: GoPro, Inc., San Mateo, CA (US)

(72) Inventors: Nicolas Rahmouni, Paris (FR); Thomas Armel Derbanne, Paris (FR); Sophana Kok, Voisins-le-Bretonneux (FR)

(21) Appl. No.: 17/444,153

(22) Filed: Jul. 30, 2021

(51) Int. Cl. H04N 5/232; G06T 7/80; G06T 7/246; G06T 7/269

(52) U.S. Cl. CPC H04N 5/23267; G06T 7/80; H04N 5/23258; G06T 7/246; H04N 5/2329; G06T 7/269

(57) ABSTRACT

Holistic systems and methods are used for calibrating image capture devices. An image capture device includes a lens, an image sensor, an inertial measurement unit (IMU), and an image signal processor (ISP). The image sensor detects images as frames and the IMU captures motion data. The ISP detects one or more key points on the frames and matches the one or more key points between the frames. The ISP computes one or more calibration parameters. The one or more calibration parameters are based on the matched key points and a model. The model includes an optical component, an IMU component, and a sensor component. The ISP performs a calibration using the calibration parameters.

### TECHNICAL FIELD

This disclosure relates to image capture methods and devices.

### BACKGROUND

Typical calibration systems and methods for image capture devices consider one part of the system while ignoring other parts of the system that may have an effect on the calibration of an electronic image stabilization (EIS) system. In addition, typical calibration systems and methods are cumbersome and must be performed during manufacture at the factory. The factory calibrations typically require a checkerboard chart and performing specific image capture device motions that are complicated and time consuming.

It would be desirable to have a calibration system and method that considers systems of the image capture device holistically with respect to calibration of the EIS system. In addition, it would be desirable to have a calibration system and method that can use a large range of visual scenes and camera motions to perform the EIS system calibration, thereby allowing a user of the image capture device perform the calibration.

### SUMMARY

Disclosed herein are implementations of systems and methods for calibrating EIS systems of image capture devices. In an aspect, an image capture device may include a lens, an image sensor, an inertial measurement unit (IMU), and an image signal processor (ISP). The image sensor may be configured to detect images as frames based on light incident on the image sensor obtained through the lens. The IMU may be configured to capture motion data. The ISP may be configured to detect one or more key points on the frames. The ISP may be configured to match the one or more key points between the frames. The ISP may be configured to compute one or more calibration parameters. The one or more calibration parameters may be based on the matched key points and a model. The model may include an optical component associated with a projection function that maps optical rays from the lens to planar points on the image sensor. The model may include an IMU component associated with the motion data. The model may include a sensor component associated with a rolling shutter line scan time. The ISP may be configured to perform a calibration using the calibration parameters.

In an aspect, a calibration method may be used in an image capture device. The calibration method may include determining images as frames based on light incident on an image sensor of the image capture device obtained through a lens of the image capture device. The method may include capturing motion data via an IMU of the image capture device. The method may include detecting one or more key points on the frames. The method may include matching the one or more key points between the frames. The method may include computing calibration parameters. The calibration parameters may be based on the matched key points and a model. The model may include an optical component associated with a projection function that maps optical rays from the lens to planar points on the image sensor. The model may include an IMU component associated with the motion data. The model may include a sensor component associated with a rolling shutter line scan time. The method may include performing a calibration by determining a set of calibration parameters for the model from the computed calibration parameters.

In an aspect, a non-transitory computer readable medium may be configured to store a set of instructions. The set of instructions, when executed by a processor, may cause the processor to divide frames into patches. The processor may detect key points on the patches. The processor may compute first local descriptors for the key points on a current frame. The processor may match the first local descriptors of the key points on the current frame to second local descriptors of the key points on a previous frame to obtain matched key points. The processor may filter the matched key points to obtain a global translation value.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-B are isometric views of an example of an image capture device.

FIGS. 2A-B are isometric views of another example of an image capture device.

FIG. 2C is a top view of the image capture device of FIGS. 2A-B.

FIG. 2D is a partial cross-sectional view of the image capture device of FIG. 2C.

FIG. 3 is a block diagram of electronic components of an image capture device.

FIG. 4 is a block diagram of a component arrangement of an image capture device.

FIG. 5 is a diagram of an example of an optical model.

FIG. 6 is a flow diagram of an example of an inertial measurement unit (IMU) model.

FIG. 7 is a flow diagram of an example of a calibration method.

FIG. 8 is a flow diagram of another example of a calibration method.

FIG. 9 is a flow diagram of an example of an offline setup method.

FIG. 10 is a flow diagram of an example of an online setup method.

### DETAILED DESCRIPTION

Imaging algorithms may be designed for specific image capture devices based on models according to the physics of the parts of the image capture device. For example, the models may be based on an EIS system, a rolling shutter correction, a lens shading correction, a stitching algorithm, or any combination thereof. Results depend on the precision of the modelization and calibration of the lens system, the inertial measurement unit (IMU), the sensor, or another image capture device component. The models may have many variables, such as, for example, the optical center of the lens, the radial distortion polynomial of the lens, the bias of the gyroscope, the size of the sensor, or any combination thereof.

The embodiments disclosed herein focus on a holistic calibration of the image sensor lens assembly (ISLA), which includes an IMU, a lens, and a sensor, for electronic video stabilization quality. Many variables are fixed during the production of the image capture device that do not vary during the lifetime of the image capture device, such as, for example, the size of the sensor. However, there are some parameters, such as the optical center or the gyroscope misalignment, that depend on the production process and present per-unit variations. Furthermore, some use cases imply large variations in the model. For example, an interchangeable lens could drastically change the distortion polynomial of the lens. The methods and systems disclosed herein may be applied to a single video or online directly in the image capture device, thereby allowing a user to perform a calibration when needed. An improved per-unit and online calibration may result in an improved and more consistent stabilization experience, an improved user experience, or both.

The disclosed calibration system may be used to improve an orientation lock mode on 360° image capture devices. The orientation lock mode may allow the user to view a spherical video from a specific orientation by locking the content of the frames during a high level of movement of the image capture device. Reprojection errors may be noticeable in the orientation lock mode for which the view should be static because it is not hidden by the residual motion of the image capture device point of view. An error as large as a few pixels can be very noticeable when viewing a video, and the disclosed calibration system is configured to reduce the average error to an order of magnitude lower than this critical value.

In addition, the calibration system does not require a complicated setup such as a checkerboard or a robotic arm to apply specific rotations. Accordingly, the calibration system may use a video sequence captured by an end-user for the calibration, and therefore the end-user may perform a calibration at any time. Since lens properties and gyroscope measures can change with the temperature, the calibration system allows the end-user to perform a calibration as needed. The calibration system may only need an infinite scene, such as a landscape, for example, while the end-user rotates the image capture device.

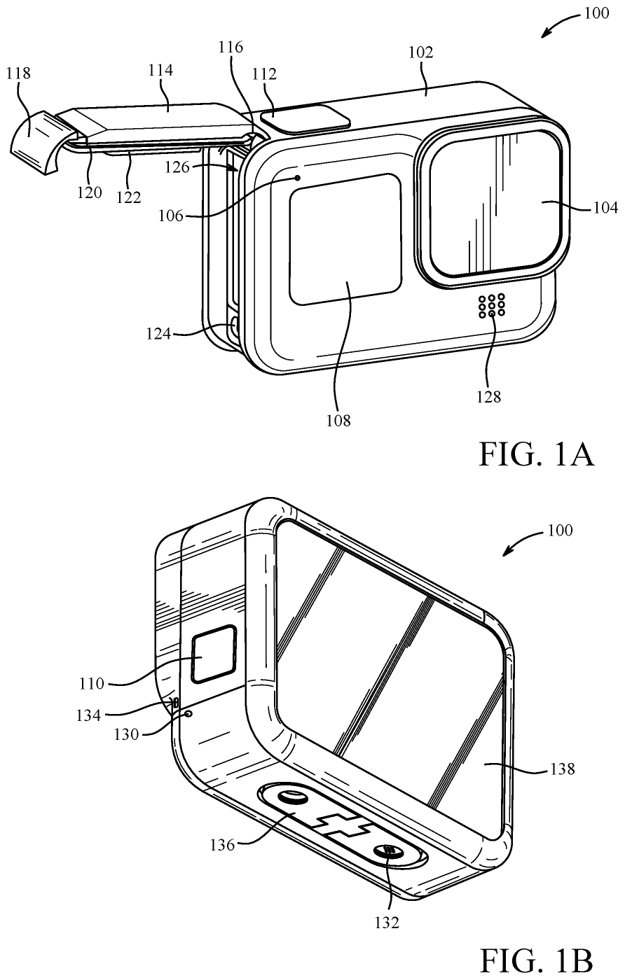

FIGS. 1A-B are isometric views of an example of an image capture device 100. The image capture device 100 may include a body 102, a lens 104 structured on a front surface of the body 102, various indicators on the front surface of the body 102 (such as light-emitting diodes (LEDs), displays, and the like), various input mechanisms (such as buttons, switches, and/or touch-screens), and electronics (such as imaging electronics, power electronics, etc.) internal to the body 102 for capturing images via the lens 104 and/or performing other functions. The lens 104 is configured to receive light incident upon the lens 104 and to direct received light onto an image sensor internal to the body 102. The image capture device 100 may be configured to capture images and video and to store captured images and video for subsequent display or playback.

The image capture device 100 may include an LED or another form of indicator 106 to indicate a status of the image capture device 100 and a liquid-crystal display (LCD) or other form of a display 108 to show status information such as battery life, camera mode, elapsed time, and the like. The image capture device 100 may also include a mode button 110 and a shutter button 112 that are configured to allow a user of the image capture device 100 to interact with the image capture device 100. For example, the mode button 110 and the shutter button 112 may be used to turn the image capture device 100 on and off, scroll through modes and settings, and select modes and change settings. The image capture device 100 may include additional buttons or interfaces (not shown) to support and/or control additional functionality.

The image capture device 100 may include a door 114 coupled to the body 102, for example, using a hinge mechanism 116. The door 114 may be secured to the body 102 using a latch mechanism 118 that releasably engages the body 102 at a position generally opposite the hinge mechanism 116. The door 114 may also include a seal 120 and a battery interface 122. When the door 114 is an open position, access is provided to an input-output (I/O) interface 124 for connecting to or communicating with external devices as described below and to a battery receptacle 126 for placement and replacement of a battery (not shown). The battery receptacle 126 includes operative connections (not shown) for power transfer between the battery and the image capture device 100. When the door 114 is in a closed position, the seal 120 engages a flange (not shown) or other interface to provide an environmental seal, and the battery interface 122 engages the battery to secure the battery in the battery receptacle 126. The door 114 can also have a removed position (not shown) where the entire door 114 is separated from the image capture device 100, that is, where both the hinge mechanism 116 and the latch mechanism 118 are decoupled from the body 102 to allow the door 114 to be removed from the image capture device 100.

The image capture device 100 may include a microphone 128 on a front surface and another microphone 130 on a side surface. The image capture device 100 may include other microphones on other surfaces (not shown). The microphones 128, 130 may be configured to receive and record audio signals in conjunction with recording video or separate from recording of video. The image capture device 100 may include a speaker 132 on a bottom surface of the image capture device 100. The image capture device 100 may include other speakers on other surfaces (not shown). The speaker 132 may be configured to play back recorded audio or emit sounds associated with notifications.

A front surface of the image capture device 100 may include a drainage channel 134. A bottom surface of the image capture device 100 may include an interconnect mechanism 136 for connecting the image capture device 100 to a handle grip or other securing device. In the example shown in FIG. 1B, the interconnect mechanism 136 includes folding protrusions configured to move between a nested or collapsed position as shown and an extended or open position (not shown) that facilitates coupling of the protrusions to mating protrusions of other devices such as handle grips, mounts, clips, or like devices.

The image capture device 100 may include an interactive display 138 that allows for interaction with the image capture device 100 while simultaneously displaying information on a surface of the image capture device 100.

The image capture device 100 of FIGS. 1A-B includes an exterior that encompasses and protects internal electronics. In the present example, the exterior includes six surfaces (i.e. a front face, a left face, a right face, a back face, a top face, and a bottom face) that form a rectangular cuboid. Furthermore, both the front and rear surfaces of the image capture device 100 are rectangular. In other embodiments, the exterior may have a different shape. The image capture device 100 may be made of a rigid material such as plastic, aluminum, steel, or fiberglass. The image capture device 100 may include features other than those described here. For example, the image capture device 100 may include additional buttons or different interface features, such as interchangeable lenses, cold shoes, and hot shoes that can add functional features to the image capture device 100.

The image capture device 100 may include various types of image sensors, such as charge-coupled device (CCD) sensors, active pixel sensors (APS), complementary metal-oxide-semiconductor (CMOS) sensors, N-type metal-oxide-semiconductor (NMOS) sensors, and/or any other image sensor or combination of image sensors.

Although not illustrated, in various embodiments, the image capture device 100 may include other additional electrical components (e.g., an image processor, camera system-on-chip (SoC), etc.), which may be included on one or more circuit boards within the body 102 of the image capture device 100.

The image capture device 100 may interface with or communicate with an external device, such as an external user interface device (not shown), via a wired or wireless computing communication link (e.g., the I/O interface 124). Any number of computing communication links may be used. The computing communication link may be a direct computing communication link or an indirect computing communication link, such as a link including another device or a network, such as the internet, may be used.

In some implementations, the computing communication link may be a Wi-Fi link, an infrared link, a Bluetooth (BT) link, a cellular link, a ZigBee link, a near field communications (NFC) link, such as an ISO/IEC 20643 protocol link, an Advanced Network Technology interoperability (ANT+) link, and/or any other wireless communications link or combination of links.

In some implementations, the computing communication link may be an HDMI link, a USB link, a digital video interface link, a display port interface link, such as a Video Electronics Standards Association (VESA) digital display interface link, an Ethernet link, a Thunderbolt link, and/or other wired computing communication link.

The image capture device 100 may transmit images, such as panoramic images, or portions thereof, to the external user interface device via the computing communication link, and the external user interface device may store, process, display, or a combination thereof the panoramic images.

The external user interface device may be a computing device, such as a smartphone, a tablet computer, a phablet, a smart watch, a portable computer, personal computing device, and/or another device or combination of devices configured to receive user input, communicate information with the image capture device 100 via the computing communication link, or receive user input and communicate information with the image capture device 100 via the computing communication link.

The external user interface device may display, or otherwise present, content, such as images or video, acquired by the image capture device 100. For example, a display of the external user interface device may be a viewport into the three-dimensional space represented by the panoramic images or video captured or created by the image capture device 100.

The external user interface device may communicate information, such as metadata, to the image capture device 100. For example, the external user interface device may send orientation information of the external user interface device with respect to a defined coordinate system to the image capture device 100, such that the image capture device 100 may determine an orientation of the external user interface device relative to the image capture device 100.

Based on the determined orientation, the image capture device 100 may identify a portion of the panoramic images or video captured by the image capture device 100 for the image capture device 100 to send to the external user interface device for presentation as the viewport. In some implementations, based on the determined orientation, the image capture device 100 may determine the location of the external user interface device and/or the dimensions for viewing of a portion of the panoramic images or video.

The external user interface device may implement or execute one or more applications to manage or control the image capture device 100. For example, the external user interface device may include an application for controlling camera configuration, video acquisition, video display, or any other configurable or controllable aspect of the image capture device 100.

The user interface device, such as via an application, may generate and share, such as via a cloud-based or social media service, one or more images, or short video clips, such as in response to user input. In some implementations, the external user interface device, such as via an application, may remotely control the image capture device 100 such as in response to user input.

The external user interface device, such as via an application, may display unprocessed or minimally processed images or video captured by the image capture device 100 contemporaneously with capturing the images or video by the image capture device 100, such as for shot framing or live preview, and which may be performed in response to user input. In some implementations, the external user interface device, such as via an application, may mark one or more key moments contemporaneously with capturing the images or video by the image capture device 100, such as with a tag or highlight in response to a user input or user gesture.

The external user interface device, such as via an application, may display or otherwise present marks or tags associated with images or video, such as in response to user input. For example, marks may be presented in a camera roll application for location review and/or playback of video highlights.

The external user interface device, such as via an application, may wirelessly control camera software, hardware, or both. For example, the external user interface device may include a web-based graphical interface accessible by a user for selecting a live or previously recorded video stream from the image capture device 100 for display on the external user interface device.

The external user interface device may receive information indicating a user setting, such as an image resolution setting (e.g., 3840 pixels by 2160 pixels), a frame rate setting (e.g., 60 frames per second (fps)), a location setting, and/or a context setting, which may indicate an activity, such as mountain biking, in response to user input, and may communicate the settings, or related information, to the image capture device 100.

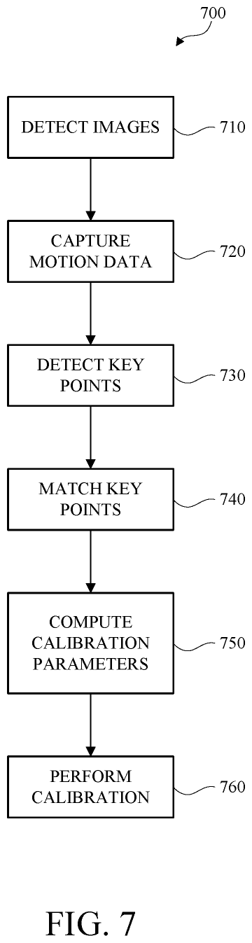

The image capture device 100 may be used to implement some or all of the methods described in this disclosure, such as methods 700, 800, 900, 1000 described in FIGS. 7-10.

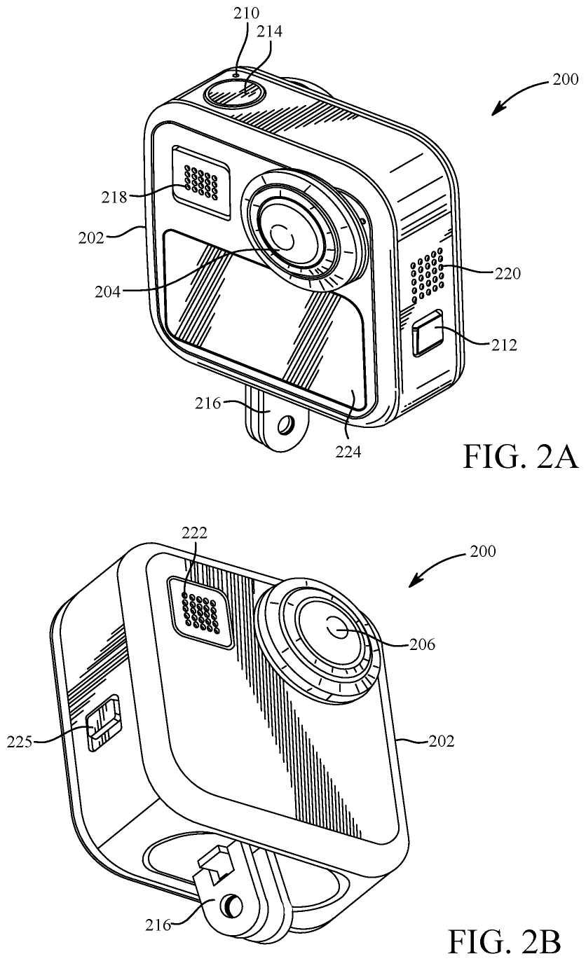

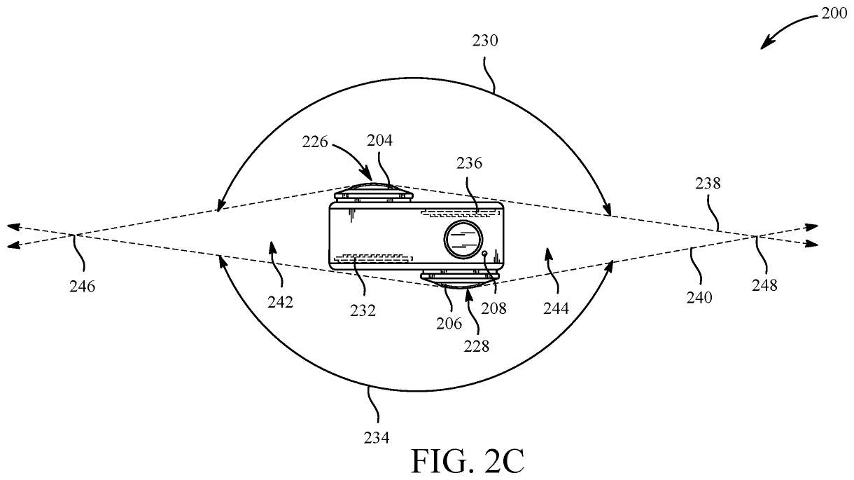

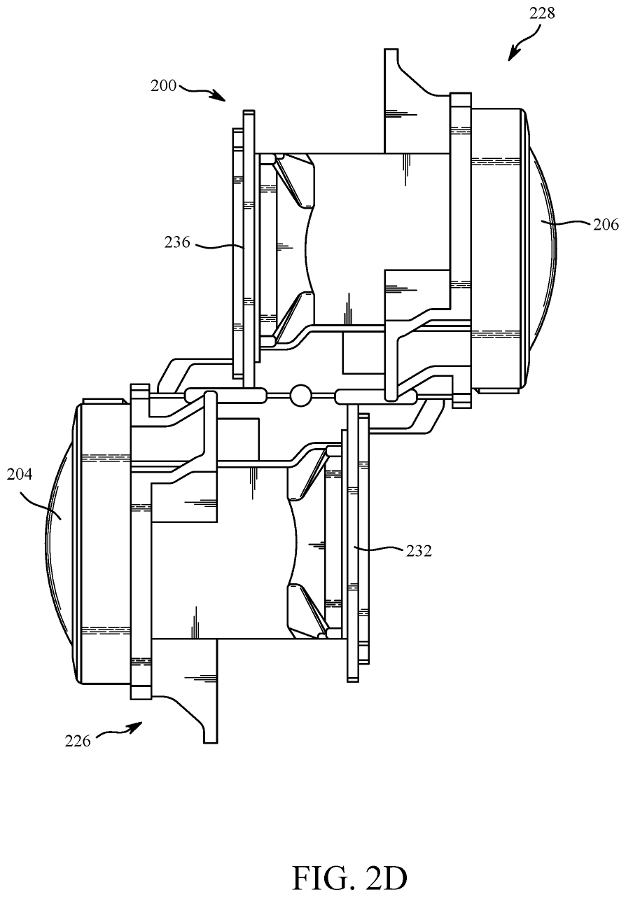

FIGS. 2A-B illustrate another example of an image capture device 200. The image capture device 200 includes a body 202 and two camera lenses 204 and 206 disposed on opposing surfaces of the body 202, for example, in a back-to-back configuration, Janus configuration, or offset Janus configuration. The body 202 of the image capture device 200 may be made of a rigid material such as plastic, aluminum, steel, or fiberglass.

The image capture device 200 includes various indicators on the front of the surface of the body 202 (such as LEDs, displays, and the like), various input mechanisms (such as buttons, switches, and touch-screen mechanisms), and electronics (e.g., imaging electronics, power electronics, etc.) internal to the body 202 that are configured to support image capture via the two camera lenses 204 and 206 and/or perform other imaging functions.

The image capture device 200 includes various indicators, for example, LEDs 208, 210 to indicate a status of the image capture device 100. The image capture device 200 may include a mode button 212 and a shutter button 214 configured to allow a user of the image capture device 200 to interact with the image capture device 200, to turn the image capture device 200 on, and to otherwise configure the operating mode of the image capture device 200. It should be appreciated, however, that, in alternate embodiments, the image capture device 200 may include additional buttons or inputs to support and/or control additional functionality.

The image capture device 200 may include an interconnect mechanism 216 for connecting the image capture device 200 to a handle grip or other securing device. In the example shown in FIGS. 2A and 2B, the interconnect mechanism 216 includes folding protrusions configured to move between a nested or collapsed position (not shown) and an extended or open position as shown that facilitates coupling of the protrusions to mating protrusions of other devices such as handle grips, mounts, clips, or like devices.

The image capture device 200 may include audio components 218, 220, 222 such as microphones configured to receive and record audio signals (e.g., voice or other audio commands) in conjunction with recording video. The audio component 218, 220, 222 can also be configured to play back audio signals or provide notifications or alerts, for example, using speakers. Placement of the audio components 218, 220, 222 may be on one or more of several surfaces of the image capture device 200. In the example of FIGS. 2A and 2B, the image capture device 200 includes three audio components 218, 220, 222, with the audio component 218 on a front surface, the audio component 220 on a side surface, and the audio component 222 on a back surface of the image capture device 200. Other numbers and configurations for the audio components are also possible.

The image capture device 200 may include an interactive display 224 that allows for interaction with the image capture device 200 while simultaneously displaying information on a surface of the image capture device 200. The interactive display 224 may include an I/O interface, receive touch inputs, display image information during video capture, and/or provide status information to a user. The status information provided by the interactive display 224 may include battery power level, memory card capacity, time elapsed for a recorded video, etc.

The image capture device 200 may include a release mechanism 225 that receives a user input to in order to change a position of a door (not shown) of the image capture device 200. The release mechanism 225 may be used to open the door (not shown) in order to access a battery, a battery receptacle, an I/O interface, a memory card interface, etc. (not shown) that are similar to components described in respect to the image capture device 100 of FIGS. 1A and 1B.

In some embodiments, the image capture device 200 described herein includes features other than those described. For example, instead of the I/O interface and the interactive display 224, the image capture device 200 may include additional interfaces or different interface features. For example, the image capture device 200 may include additional buttons or different interface features, such as interchangeable lenses, cold shoes, and hot shoes that can add functional features to the image capture device 200.

FIG. 2C is a top view of the image capture device 200 of FIGS. 2A-B and FIG. 2D is a partial cross-sectional view of the image capture device 200 of FIG. 2C. The image capture device 200 is configured to capture spherical images, and accordingly, includes a first image capture device 226 and a second image capture device 228. The first image capture device 226 defines a first field-of-view 230 and includes the lens 204 that receives and directs light onto a first image sensor 232. Similarly, the second image capture device 228 defines a second field-of-view 234 and includes the lens 206 that receives and directs light onto a second image sensor 236. To facilitate the capture of spherical images, the image capture devices 226 and 228 (and related components) may be arranged in a back-to-back (Janus) configuration such that the lenses 204, 206 face in generally opposite directions.

The fields-of-view 230, 234 of the lenses 204, 206 are shown above and below boundaries 238, 240 indicated in dotted line. Behind the first lens 204, the first image sensor 232 may capture a first hyper-hemispherical image plane from light entering the first lens 204, and behind the second lens 206, the second image sensor 236 may capture a second hyper-hemispherical image plane from light entering the second lens 206.

One or more areas, such as blind spots 242, 244 may be outside of the fields-of-view 230, 234 of the lenses 204, 206 so as to define a “dead zone.” In the dead zone, light may be obscured from the lenses 204, 206 and the corresponding image sensors 232, 236, and content in the blind spots 242, 244 may be omitted from capture. In some implementations, the image capture devices 226, 228 may be configured to minimize the blind spots 242, 244.

The fields-of-view 230, 234 may overlap. Stitch points 246, 248 proximal to the image capture device 200, that is, locations at which the fields-of-view 230, 234 overlap, may be referred to herein as overlap points or stitch points. Content captured by the respective lenses 204, 206 that is distal to the stitch points 246, 248 may overlap.

Images contemporaneously captured by the respective image sensors 232, 236 may be combined to form a combined image. Generating a combined image may include correlating the overlapping regions captured by the respective image sensors 232, 236, aligning the captured fields-of-view 230, 234, and stitching the images together to form a cohesive combined image.

A slight change in the alignment, such as position and/or tilt, of the lenses 204, 206, the image sensors 232, 236, or both, may change the relative positions of their respective fields-of-view 230, 234 and the locations of the stitch points 246, 248. A change in alignment may affect the size of the blind spots 242, 244, which may include changing the size of the blind spots 242, 244 unequally.

Incomplete or inaccurate information indicating the alignment of the image capture devices 226, 228, such as the locations of the stitch points 246, 248, may decrease the accuracy, efficiency, or both of generating a combined image. In some implementations, the image capture device 200 may maintain information indicating the location and orientation of the lenses 204, 206 and the image sensors 232, 236 such that the fields-of-view 230, 234, the stitch points 246, 248, or both may be accurately determined; the maintained information may improve the accuracy, efficiency, or both of generating a combined image.

The lenses 204, 206 may be laterally offset from each other, may be off-center from a central axis of the image capture device 200, or may be laterally offset and off-center from the central axis. As compared to image capture devices with back-to-back lenses, such as lenses aligned along the same axis, image capture devices including laterally offset lenses may include substantially reduced thickness relative to the lengths of the lens barrels securing the lenses. For example, the overall thickness of the image capture device 200 may be close to the length of a single lens barrel as opposed to twice the length of a single lens barrel as in a back-to-back lens configuration. Reducing the lateral distance between the lenses 204, 206 may improve the overlap in the fields-of-view 230, 234. In another embodiment (not shown), the lenses 204, 206 may be aligned along a common imaging axis.

Images or frames captured by the image capture devices 226, 228 may be combined, merged, or stitched together to produce a combined image, such as a spherical or panoramic image, which may be an equirectangular planar image. In some implementations, generating a combined image may include use of techniques including noise reduction, tone mapping, white balancing, or other image correction. In some implementations, pixels along the stitch boundary may be matched accurately to minimize boundary discontinuities.

The image capture device 200 may be used to implement some or all of the methods described in this disclosure, such as methods 700, 800, 900, 1000 described in FIGS. 7-10.

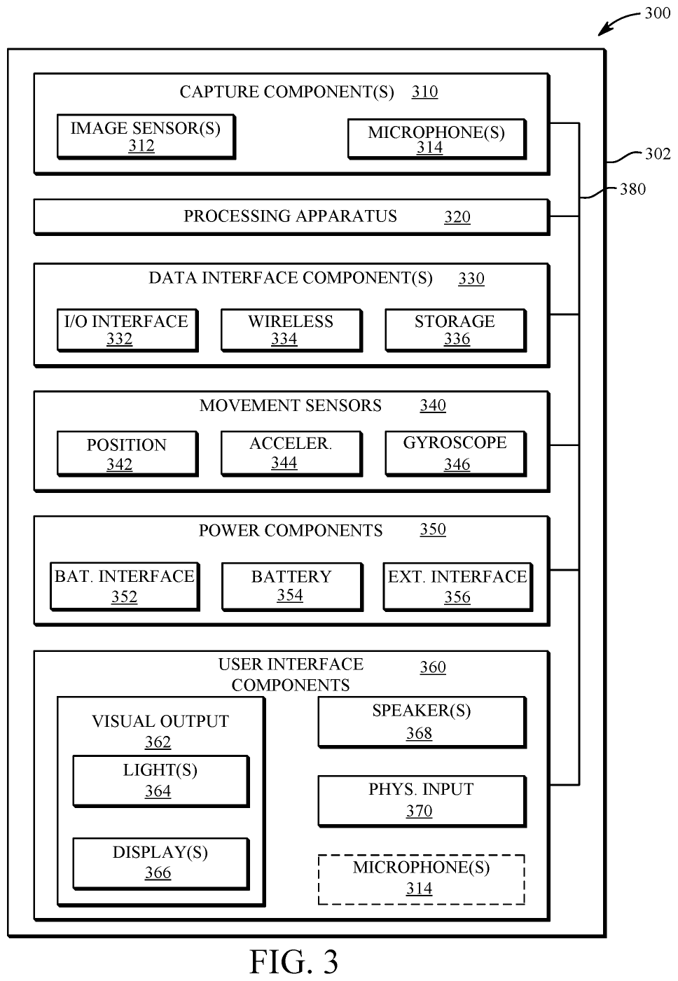

FIG. 3 is a block diagram of electronic components in an image capture device 300. The image capture device 300 may be a single-lens image capture device, a multi-lens image capture device, or variations thereof, including an image capture device with multiple capabilities such as use of interchangeable integrated sensor lens assemblies. The description of the image capture device 300 is also applicable to the image capture devices 100, 200 of FIGS. 1A-B and 2A-D.

The image capture device 300 includes a body 302 which includes electronic components such as capture components 310, a processing apparatus 320, data interface components 330, movement sensors 340, power components 350, and/or user interface components 360.

The capture components 310 include one or more image sensors 312 for capturing images and one or more microphones 314 for capturing audio.

The image sensor(s) 312 is configured to detect light of a certain spectrum (e.g., the visible spectrum or the infrared spectrum) and convey information constituting an image as electrical signals (e.g., analog or digital signals). The image sensor(s) 312 detects light incident through a lens coupled or connected to the body 302. The image sensor(s) 312 may be any suitable type of image sensor, such as a charge-coupled device (CCD) sensor, active pixel sensor (APS), complementary metal-oxide-semiconductor (CMOS) sensor, N-type metal-oxide-semiconductor (NMOS) sensor, and/or any other image sensor or combination of image sensors. Image signals from the image sensor(s) 312 may be passed to other electronic components of the image capture device 300 via a bus 380, such as to the processing apparatus 320. In some implementations, the image sensor(s) 312 includes a digital-to-analog converter. A multi-lens variation of the image capture device 300 can include multiple image sensors 312.

The microphone(s) 314 is configured to detect sound, which may be recorded in conjunction with capturing images to form a video. The microphone(s) 314 may also detect sound in order to receive audible commands to control the image capture device 300.

The processing apparatus 320 may be configured to perform image signal processing (e.g., filtering, tone mapping, stitching, and/or encoding) to generate output images based on image data from the image sensor(s) 312. The processing apparatus 320 may include one or more processors having single or multiple processing cores. In some implementations, the processing apparatus 320 may include an application specific integrated circuit (ASIC). For example, the processing apparatus 320 may include a custom image signal processor. The processing apparatus 320 may exchange data (e.g., image data) with other components of the image capture device 300, such as the image sensor(s) 312, via the bus 380.

The processing apparatus 320 may include memory, such as a random-access memory (RAM) device, flash memory, or another suitable type of storage device, such as a non-transitory computer-readable memory. The memory of the processing apparatus 320 may include executable instructions and data that can be accessed by one or more processors of the processing apparatus 320. For example, the processing apparatus 320 may include one or more dynamic random-access memory (DRAM) modules, such as double data rate synchronous dynamic random-access memory (DDR SDRAM). In some implementations, the processing apparatus 320 may include a digital signal processor (DSP). More than one processing apparatus may also be present or associated with the image capture device 300.

The data interface components 330 enable communication between the image capture device 300 and other electronic devices, such as a remote control, a smartphone, a tablet computer, a laptop computer, a desktop computer, or a storage device. For example, the data interface components 330 may be used to receive commands to operate the image capture device 300, transfer image data to other electronic devices, and/or transfer other signals or information to and from the image capture device 300. The data interface components 330 may be configured for wired and/or wireless communication. For example, the data interface components 330 may include an I/O interface 332 that provides wired communication for the image capture device, which may be a USB interface (e.g., USB type-C), a high-definition multimedia interface (HDMI), or a FireWire interface. The data interface components 330 may include a wireless data interface 334 that provides wireless communication for the image capture device 300, such as a Bluetooth interface, a ZigBee interface, and/or a Wi-Fi interface. The data interface components 330 may include a storage interface 336, such as a memory card slot configured to receive and operatively couple to a storage device (e.g., a memory card) for data transfer with the image capture device 300 (e.g., for storing captured images and/or recorded audio and video).

The movement sensors 340 may detect the position and movement of the image capture device 300. The movement sensors 340 may include a position sensor 342, an accelerometer 344, or a gyroscope 346. The position sensor 342, such as a global positioning system (GPS) sensor, is used to determine a position of the image capture device 300. The accelerometer 344, such as a three-axis accelerometer, measures linear motion (e.g., linear acceleration) of the image capture device 300. The gyroscope 346, such as a three-axis gyroscope, measures rotational motion (e.g., rate of rotation) of the image capture device 300. Other types of movement sensors 340 may also be present or associated with the image capture device 300.

The power components 350 may receive, store, and/or provide power for operating the image capture device 300. The power components 350 may include a battery interface 352 and a battery 354. The battery interface 352 operatively couples to the battery 354, for example, with conductive contacts to transfer power from the battery 354 to the other electronic components of the image capture device 300. The power components 350 may also include an external interface 356, and the power components 350 may, via the external interface 356, receive power from an external source, such as a wall plug or external battery, for operating the image capture device 300 and/or charging the battery 354 of the image capture device 300. In some implementations, the external interface 356 may be the I/O interface 332. In such an implementation, the I/O interface 332 may enable the power components 350 to receive power from an external source over a wired data interface component (e.g., a USB type-C cable).

The user interface components 360 may allow the user to interact with the image capture device 300, for example, providing outputs to the user and receiving inputs from the user. The user interface components 360 may include visual output components 362 to visually communicate information and/or present captured images to the user. The visual output components 362 may include one or more lights 364 and/or more displays 366. The display(s) 366 may be configured as a touch screen that receives inputs from the user. The user interface components 360 may also include one or more speakers 368. The speaker(s) 368 can function as an audio output component that audibly communicates information and/or presents recorded audio to the user. The user interface components 360 may also include one or more physical input interfaces 370 that are physically manipulated by the user to provide input to the image capture device 300. The physical input interfaces 370 may, for example, be configured as buttons, toggles, or switches. The user interface components 360 may also be considered to include the microphone(s) 314, as indicated in dotted line, and the microphone(s) 314 may function to receive audio inputs from the user, such as voice commands.

The image capture device 300 may be used to implement some or all of the methods described in this disclosure, such as methods 700, 800, 900, 1000 described in FIGS. 7-10.

In the embodiments disclosed herein, the whole stabilization system is considered for calibration, rather than calibrating each component separately. The embodiments disclosed herein may not require a complicated setup with specific objects in front of the image capture device to detect a specific motion sequence. For example, any video of any scene may lead to reasonable calibration results when the system is correctly excited.

The displacement of a projection on the sensor of any three-dimensional (3D) point at infinite distance between frames may be modeled. Stabilizing a video may include inverting this displacement for all pixels and warping the input frame accordingly. The model may be dependent upon the calibration of one or more parameters.

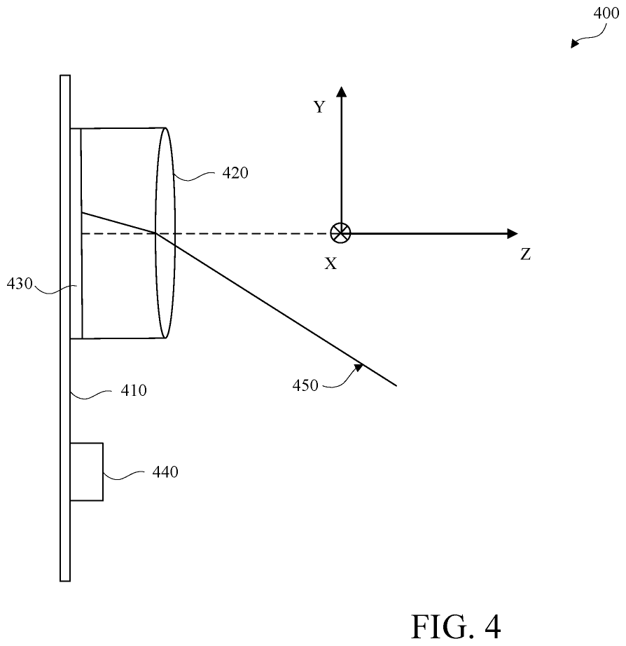

FIG. 4 is a block diagram of a component arrangement of an image capture device 400. The image capture device 400 may be any image capture device, such as the image capture device 100 shown in FIGS. 1A-1B, image capture device 200 shown in FIGS. 2A-2D, or image capture device 300 shown in FIG. 3. As shown in FIG. 4, the image capture device 400 includes a body 410, a lens 420, a sensor 430, and an IMU 440, where a light ray 450 can enter the lens 420 and be detected by the sensor 430. The camera coordinate system ( [symbol] ) is aligned with the [symbol] sensor 430 such that the z-axis is perpendicular to the sensor 430 and the x-axis and the y-axis are coplanar with the sensor 430.

The sensor 430 and the IMU 440 may be mounted to the body 410. In theory, the lens 420 and the sensor 430 are perfectly aligned and are separated by a fixed distance (i.e., the focal length), and the orientation of the IMU 440 is the same as the orientation of the sensor 430. In practice, however, there are some deviations, for example, the IMU 440 may not be perfectly aligned or the lens 420 may be slightly shifted with respect to the sensor.

The body 410 is rigid, therefore it has 6 degrees of freedom, for example 3 degrees of rotation and 3 degrees of translation. In an example where the displacement of a non-moving 3D point from the perspective of two different image capture device positions ( [symbol] ₀) and ( [symbol] ₁) is to be measured, the coordinates of the point in ( [symbol] ₀) are (X₀). The coordinates of the new image capture device position may be computed with (X₁=RX₀+t).

In an example pinhole projection model

$$( x = X \frac{f}{z} Y \frac{f}{z} )$$

with (f) the focal length of the lens 420, the displacement may be computed in pixel for a pure translation (t) with a camera model

$$( δ p = \frac{f}{z} t ) .$$

In this example, one pixel may measure approximately 0.8 μm and the focal length may be approximately 2.9 mm. Accordingly, for a point at 1 m distance, a translation of approximately 0.27 mm may result in a displacement of 1 pixel on the sensor 430. However, when the points are at 10 m or 100 m, the minimal translation to observe a displacement of 1 pixel is respectively 2.7 mm and 2.7 cm, which is a large deviation to obtain between two consecutive frames of video. Accordingly, for objects that are far enough away from the image capture device, the impact of translation may be ignored to simplify the computation with only 3 degrees of freedom for the rotation. The reprojection model for points that are far and non-moving may be described from the gyroscope signal of the IMU, which may be the actual measure of the rotation between two framed detected by the image capture device. The reprojection model may be compared to actual measurements of the frames, for example, via key point matching, to calibrate the reprojection model.

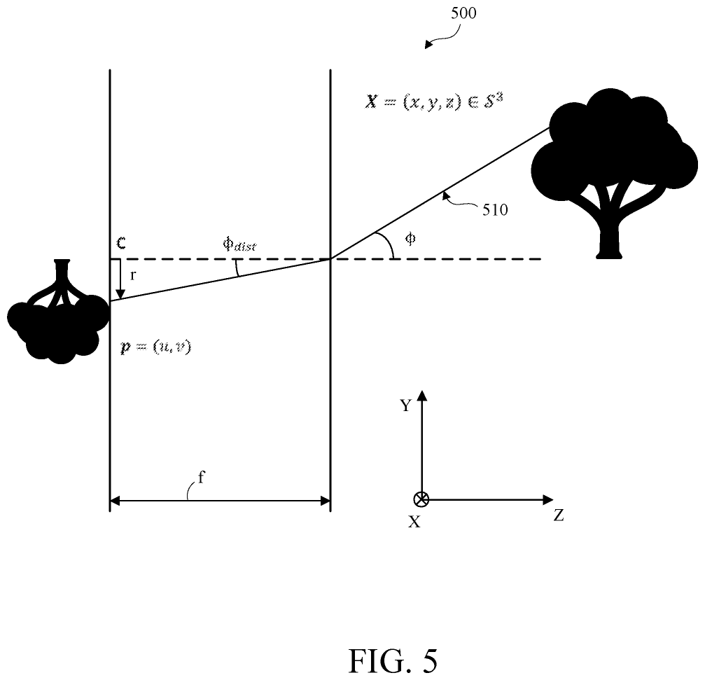

FIG. 5 is a diagram of an example of an optical model 500. The optical model 500 describes what happens with the lens and sensor of an image capture device, such as the lens 420 and sensor 430 shown in FIG. 4. In mathematical terms, this may be described by a projection function (p_{θ}) (and its inverse (q_{θ}) that maps optical rays 510 to planar points p on the sensor.

Since lenses are not perfect pinholes and often introduce radial distortions, these radial distortions should be taken into account to determine the optical model 500. The lens in this example has a focal length f. When the optical ray 510 is projected on the sensor, the optical center of the lens ((cₓ, c_{y})) and the polynomial coefficients (α₁, α₃, α₅, α₇) are known. Accordingly, the following may be computed:

$$r = h ( ∅ ) = {α}_{1} ∅ + {α}_{3} {∅}^{3} + {α}_{5} {∅}^{5} + {α}_{7} {∅}^{7} \qquad Equation ( 1 )$$

$$u = r \frac{x}{\sqrt{{x}^{2} + {y}^{2}}} + {c}_{x} \qquad Equation ( 2 )$$

$$v = r \frac{y}{\sqrt{{x}^{2} + {y}^{2}}} + {c}_{y} \qquad Equation ( 3 )$$

In the embodiments described herein, optical calibration may be defined as determining the adapted parameters to match the behavior of the image capture device components. With this model, any point of the 3D space may be used to determine the position of the corresponding pixel on the sensor.

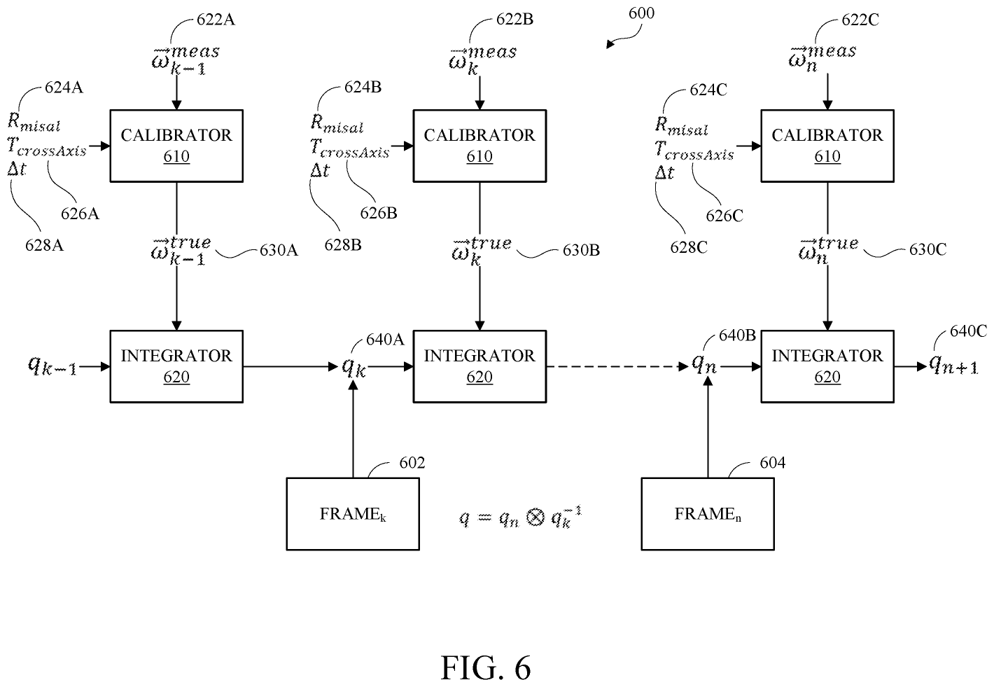

FIG. 6 is a flow diagram of an example of an IMU model 600. An IMU may include a gyroscope that is configured to measure rotations of the image capture device body. The measured rotations may be referred to as angular speed. Typical gyroscopes have flaws that should be taken into account for calibration. The IMU model 600 is configured to take these flaws into account. In this example, (\vec{ωₜᵣᵤₑ}) is the true infinitesimal rotation of the image capture device body and (\vec{ωₘₑₐₛ}) is the rotation measured by the IMU.

Parameters that may be calibrated include misalignment, cross-axis sensitivity and scale, time delay, bias, or any combination thereof. For misalignment, it is possible that the IMU is not perfectly aligned with the image capture body. Accordingly, a 3 degree of freedom rotation (Rₘᵢₛₐₗ) may be applied to correct for the misalignment. For cross-axis sensitivity and scale, each axis of the rotation can be impacted by the other axes, whether it is an electro-magnetic effect inside a micro-electromechanical system (MEMS) or a scaling that is incorrect. This may be modeled by a 6 degree of freedom triangular matrix (T_{crossAxis}). Regarding the time delay, the IMU may have an internal clock that is not always synchronized with the image timestamps. In addition, there may be a group timestamp synchronization, therefore the model may take into account the time delay (Δt). Regarding bias, the measurements may be biased for a low cost IMU. However, the value may depend on the temperature and the impact on small time differences may be neglectable. Accordingly, some models may omit the bias parameter. The formula for the true rotation based on the IMU measures is shown below:

\vec{ωₜᵣᵤₑ}(t)=RₘᵢₛₐₗT_{crossAxis}\vec{ωₘₑₐₛ}(t+Δt) Equation (4)

Point displacements between frames are measured for calibration, therefore infinitesimal rotation is not needed, rather actual rotations between two arbitrary times may be used. Accordingly, the measured IMU signal may be integrated with respect to the time. The angular speed may be integrated to form quaternions. The quaternions may be used to derive one or more differential equations that once integrated result in a recursive formula to compute the rotation at time (t) between the image capture device body and the initial position of the image capture device. The recursive formula is shown below:

$$q ( t + dt ) = exp ( \frac{1}{2} {{ω}_{true}}^{⟶} dt ) ⊗ q ( t ) \qquad Equation ( 5 )$$

with (⊗) being the quaternion product operator.

Referring to FIG. 6, the IMU model 600 shows how the IMU measures can be converted to rotation between frames, such as frame 602 and frame 604. The IMU model 600 includes a calibrator 610 and an integrator 620. As shown in FIG. 6, the measured rotation 622A-622C, misalignment 624A-624C, cross-axis sensitivity and scale 626A-626C, and time delay 628A-628C of each frame are input to the calibrator 610. The calibrator 610 is configured to compute a true rotation 630A-630C of the frames based on Equation (4) above. As shown in FIG. 6, the integrator 620 is configured to perform an integration of the true rotations 630A-630C to form quaternions, such as quaternions 640A-640C. The quaternions 640A-640C may be used to compute the rotation at time (t) between the image capture device body and the initial position of the image capture device using Equation (5) above. For a precise rotation measure, in some examples, an interpolation may be performed between IMU samples. In order to perform the interpolation, the correct (dt) should be selected as the IMU measure to be constant during the integration time

$$( \frac{1}{6400} Hz = 156 µs ) ,$$

for example. Using the IMU model 600, the exact rotation of the image capture body can be determined between two arbitrary times. This may be useful to project points from one frame to another to compute a theoretical displacement.

In some examples, an image capture device may have a rolling shutter sensor that is configured to expose each pixel line at a different time. The rolling shutter sensor allows for a better throughput because the pixels can be sent to the internal memory more efficiently. However, this creates a problem for image stabilization such that the pixels are now sampled at a different time on the sensor so that they undergo a different rotation. A time model may be used to correct for this. In an example where a pixel position is ((x, y)) on the sensor, the corresponding time may be determined as

$$t ( x , y ) = {t}_{0} + {τ}_{scan} \frac{y - H / 2}{H} ,$$

where (τ_{scan}) is the line scan time and (H) is the sensor height in a pixel value. The line scan time and the sensor height may not need to be calibrated in some examples.

In the embodiments disclosed herein, for far, non-moving 3D points detected by the image capture device, movement of these 3D points may be modeled by a rotation. The formula x=p_{θ}(X) may be used to project 3D rays on the sensor, and the formula X=q_{θ}(x) may be used to convert sensor points to 3D rays. The rotation between two arbitrary times may be computed based on IMU measurements and the time of exposition for each of the points on the sensor may be determined. Accordingly, given the projection (x₀) of a 3D point (X) in a frame at a time (t₀), the projection (x₁) of the same point at another time (t₁) may be determined as follows:

x(t₁)=p_{θ}(q_{θ}(x₀)R(t₁,t₀)) Equation (6)

where R(t₁, t₀) is the rotation between t₁ and t₀ determined by the integration of the IMU.

Calibration methods described herein may compare one or more models described herein with observations of 3D points projected on the sensor of an image capture device and adapt one or more parameters to match the observations. The methods may use a point matching algorithm with key point detection and a description scheme to extract sparse point matches between frames. Any algorithm such as a scale-invariant feature transform (SIFT) algorithm or a features from accelerated segment test (FAST) algorithm may be used.

The sparse optical flow may be used as observations to calibrate the system. In an example, the model [symbol] may have a set of parameters (θ) and relate the two-dimensional (2D) position (xᵢ^{t}) of an object (i) on the sensor for a frame (t) to the same object in frame (t+1), which may be noted as (xᵢ^{t+1}) in the equation below:

xᵢ^{t+1}= [symbol] (xᵢ^{t},θ) Equation (7)

The calibration methods may be used to determine (\tilde{θ}) such that the deviation from this model is minimal on the dataset ( [symbol] ) of the sparse point match. This transduces by:

\tilde{θ}=argmin_{θ} [symbol] ρ(∥xᵢ^{t+1}− [symbol] (xᵢ^{t},θ)∥²) Equation (8)

where ρ(⋅) is a robust cost function to process outliers. This formulation may be used in an offline setup where the dataset ( [symbol] ) is known in advance, as well as an online setup where ( [symbol] ) grows as new frames are collected. In some online setup examples, continuous learning methods may be used.

FIG. 7 is a flow diagram of an example of a calibration method 700. The calibration method 700 may be performed by an image capture device, such as the image capture device 100 shown in FIGS. 1A-1B, image capture device 200 shown in FIGS. 2A-2D, or image capture device 300 shown in FIG. 3. The calibration method 700 includes detecting 710 images, for example, using one or more image sensors. The one or more image sensors are configured to detect the images as frames based on light incident on the one or more image sensors obtained through one or more lenses of the image capture device.

The calibration method 700 includes capturing 720 motion data. The motion data may be captured using an IMU. The calibration method 700 includes detecting 730 key points on the frames and matching 740 the key points between the frames. The frames may be consecutive frames or non-consecutive frames. The key points may be detected and matched using an image signal processor (ISP) of the image capture device. The matched key points form a dataset [symbol] ={(xᵢ^{t},xᵢ^{t+1})∀(i,t)∈V}.

The calibration method 700 includes computing 750 calibration parameters. The calibration parameters may be computed by the ISP. The calibration parameters may be computed based on a model that includes an optical component, an IMU component, and a sensor component. The optical component may be associated with a projection function that maps optical rays from the lens to planar points on the image sensor. The IMU component may be associated with the motion data captured by the IMU. The sensor component may be associated with a rolling shutter line scan time. The calibration parameters may be computed using Equation (8) above. In some examples, a global deviation may be computed from the model, for example, using Equation (7) shown above. The global deviation may be computed as the average difference between the left and right sides of Equation (7). In these examples, the global deviation may be minimized with respect to the parameters of the model using an iterative method, such as the Levenberg-Marquardt method, for example. Using Equation (8), the global deviation of the model can be minimized with respect to the points of the dataset to find the calibration parameters.

The calibration method 700 includes performing 760 a calibration. Performing 760 the calibration may include applying one or more computed calibration parameters to a respective component of the image capture device. For example, computed calibration parameters associated with the optical component may be applied to the projection function, computed calibration parameters associated with the IMU component may be applied to the IMU to adjust the motion data captured by the IMU, and computed calibration parameters associated with the sensor component may be applied to the rolling shutter to adjust the rolling shutter line scan time.

Performing 760 the calibration may include determining the correct set of parameters (θ) for the model. The parameters include optical parameters and IMU parameters. The optical parameters may include an optical center (cₓ, c_{y}) and distortion polynomial coefficients (α₁, α₃, α₅, α₇). The IMU parameters may be gyroscope parameters, and include a misalignment matrix Rₘᵢₛₐₗ, a cross-axis sensitivity T_{crossAxis}, and a time delay Δt. To determine the correct parameters, a classification method or a regression method may be performed.

The classification method includes selecting the parameters from a set of known calibrations. The correct parameters may be selected from proposals Θ={θ₀, θ₁, . . . , θₙ}. The error of the model may be computed from the dataset for each set of parameters to select the one that minimizes the reprojection error, as shown by the equation below:

θ=argmin_{Θ} [symbol] ∥x₁−p_{θ}(q_{θ}(x₀)R(t₁,t₀))∥² Equation (9)

In some examples, the optimal parameters may be determined for each frame and smoothed over time.

The regression method may be used to finely calibrate the model. Since a set of prior parameters may not be available, the reprojection error may be minimized on the full available space [symbol] ¹⁶, as shown by the equation below:

θ= [symbol] [symbol] ∥x₁−p_{θ}(q_{θ}(x₀)R(t₁,t₀))∥² Equation (10)

The regression may be performed using a gradient decent method, for example, an iterative gradient decent method. Starting from an initial calibration, the loss gradient steps may be iterated. The error may be fully differentiable and may be automatically differentiated by standard packages, such as PyTorch, for example. In some examples, a Levenberg-Marquardt algorithm may be used to minimize the error.

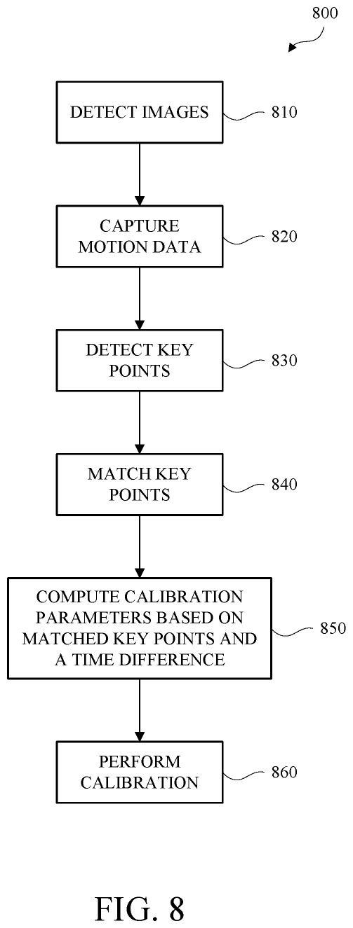

FIG. 8 is a flow diagram of another example of a calibration method 800. The calibration method 800 may be performed by an image capture device, such as the image capture device 100 shown in FIGS. 1A-1B, image capture device 200 shown in FIGS. 2A-2D, or image capture device 300 shown in FIG. 3. The calibration method 800 includes detecting 810 images, for example, using one or more image sensors. The one or more image sensors are configured to detect the images as frames based on light incident on the one or more image sensors obtained through one or more lenses of the image capture device.

The calibration method 800 includes capturing 820 motion data. The motion data may be captured using an IMU. The calibration method 800 includes detecting 830 key points on the frames and matching 840 the key points between the frames. The frames may be consecutive frames or non-consecutive frames. The key points may be detected and matched using an image signal processor (ISP) of the image capture device. The matched key points form a dataset [symbol] ={(xᵢ^{t},xᵢ^{t+1})∀(i,t)∈V}.

The calibration method 800 includes computing 850 calibration parameters. The calibration parameters may be computed by the ISP. The calibration parameters may be computed based on the matched key points and a time difference between the ISP and the IMU. The calibration parameters may be computed using Equation (8) above. In some examples, a global deviation may be computed, for example, using Equation (7) shown above. The global deviation may be computed as the average difference between the left and right sides of Equation (7). In these examples, the global deviation may be minimized with respect to the parameters of the model using an iterative method, such as the Levenberg-Marquardt method, for example. Using Equation (8), the global deviation of the model can be minimized with respect to the points of the dataset to find the calibration parameters.

The calibration method 800 includes performing 860 a calibration. Performing 860 the calibration may include applying one or more computed calibration parameters to a respective component of the image capture device. For example, computed calibration parameters associated with an optical component may be applied to the projection function, and the calibration parameters based on the time difference between the ISP and the IMU may be applied to a timing of the ISP, a timing of the IMU, or both, to synchronize the timings of the ISP and the IMU.

Performing 860 the calibration may include determining the correct set of parameters (θ) for the model. The parameters include optical parameters and IMU parameters. The optical parameters may include an optical center (cₓ, c_{y}) and distortion polynomial coefficients (α₁, α₃, α₅, α₇). The IMU parameters may be gyroscope parameters, and include a misalignment matrix Rₘᵢₛₐₗ, a cross-axis sensitivity T_{crossAxis}, and a time delay Δt. To determine the correct parameters, a classification method or a regression method may be performed.

The classification method includes selecting the parameters from a set of known calibrations. The correct parameters may be selected from proposals Θ={θ₀, θ₁, . . . , θₙ}. The error of the model may be computed from the dataset for each set of parameters to select the one that minimizes the reprojection error, as shown by Equation (9) above. In some examples, the optimal parameters may be determined for each frame and smoothed over time.

The regression method may be used to finely calibrate the model. Since a set of prior parameters may not be available, the reprojection error may be minimized on the full available space [symbol] ¹⁶, as shown by Equation (10) above. The regression may be performed using a gradient decent method, for example, an iterative gradient decent method. Starting from an initial calibration, the loss gradient steps may be iterated. The error may be fully differentiable and may be automatically differentiated by standard packages, such as PyTorch, for example. In some examples, a Levenberg-Marquardt algorithm may be used to minimize the error.

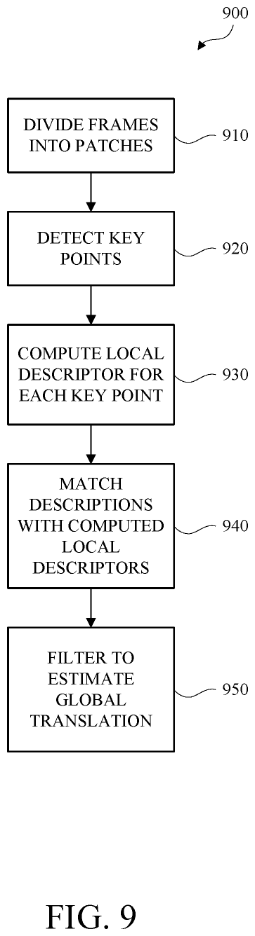

FIG. 9 is a flow diagram of an example of an offline setup method 900. The offline setup method 900 includes dividing 910 frames into patches. The frames may be divided into any number of patches. For example, the frame may be divided into 12 patches or 16 patches. The offline setup method 900 includes detecting 920 key points for each patch. The key points may be detected at different scales by determining extremas of a metric based on the structure tensor eigen values. An example of the metric may be any point matching algorithm, such as a SIFT algorithm. The offline setup method 900 includes computing 930 a local descriptor for each key point. The local descriptor may be computed around the position of the key point. The local descriptor may be based on a histogram, a gradient, or any other description. The offline setup method 900 includes matching 940 the local descriptors of the current frame with the local descriptors computed on previous frames to match key points. The matching may be performed using an algorithm, such as a k nearest neighbors (KNN) algorithm, for example. The offline setup method 900 includes filtering 950 the matched key points to estimate a global translation value. The filtering 950 may be performed using a random sample consensus (RANSAC) algorithm to remove the outliers and estimate the global translation value. The offline setup method 900 may be applied to any pair of frames in a video. For example, consecutive frames or non-consecutive frames may be used.

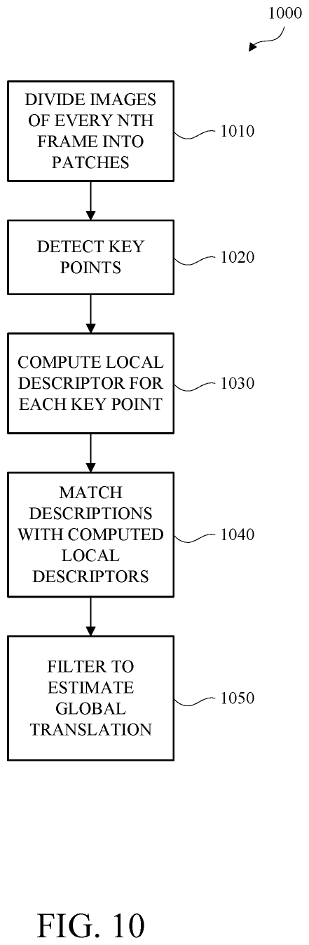

FIG. 10 is a flow diagram of an example of an online setup method 1000. The online setup method 1000 includes dividing 1010 every Nth frame into patches. The frames may be divided into any number of patches. For example, the frames may be divided into 12 patches or 16 patches. The online setup method 1000 includes detecting 1020 key points for each patch. The key points may be detected at different scales by determining extremas of a metric based on the structure tensor eigen values. An example of the metric may be any point matching algorithm, such as a SIFT algorithm. The online setup method 1000 includes computing 1030 a local descriptor for each key point. The local descriptor may be computed around the position of the key point. The local descriptor may be based on a histogram, a gradient, or any other description. The online setup method 1000 includes matching 1040 the local descriptors of the current frame with the local descriptors computed on previous frames to match key points. The matching may be performed using an algorithm, such as a KNN algorithm, for example. The online setup method 1000 includes filtering 1050 the matched key points to estimate a global translation value. The filtering 1050 may be performed using a RANSAC algorithm to remove the outliers and estimate the global translation value. The online setup method 1000 may be applied to any pair of frames in a video. For example, consecutive frames or non-consecutive frames may be used.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An image capture device comprising:
a lens;
an image sensor configured to detect images as frames based on light incident on the image sensor obtained through the lens;
an inertial measurement unit (IMU) configured to capture motion data; and
an image signal processor (ISP) configured to:
detect key points on the frames;
match the key points between the frames;
compute calibration parameters based on the matched key points, an optical component associated with a projection function that maps optical rays from the lens to planar points on the image sensor, an IMU component associated with the motion data, and a sensor component associated with a rolling shutter line scan time; and
perform a calibration using the calibration parameters.

2. The image capture device of claim 1, wherein the ISP is configured to detect the key points at different scales.

3. The image capture device of claim 2, wherein the ISP is configured to determine an extrema of a metric based on a structure tensor eigen value to detect the key points at different scales.

4. The image capture device of claim 3, wherein the metric is a scale-invariant feature transform (SIFT) algorithm.

5. The image capture device of claim 1, wherein the ISP is configured to use a k nearest neighbors (KNN) algorithm to match the key points between the frames.

6. The image capture device of claim 1, wherein the calibration parameters include optical parameters and IMU parameters.

7. The image capture device of claim 6, wherein the optical parameters include an optical center and one or more distortion polynomial coefficients.

8. The image capture device of claim 6, wherein the IMU parameters include a misalignment matrix, a cross-axis sensitivity, and a time delay.

9. A calibration method for use in an image capture device, the calibration method comprising:
detecting images as frames based on light incident on an image sensor of the image capture device obtained through a lens of the image capture device;
capturing motion data via an inertial measurement unit (IMU) of the image capture device;
detecting key points on the frames;
matching the key points between the frames;
computing calibration parameters based on the matched key points and a model that includes an optical component associated with a projection function that maps optical rays from the lens to planar points on the image sensor, an IMU component associated with the motion data, and a sensor component associated with a rolling shutter line scan time; and
performing a calibration by determining a set of calibration parameters for the model from the computed calibration parameters.

10. The method of claim 9, wherein determining the set of calibration parameters for the model is based on a set of known calibrations.

11. The method of claim 9, wherein determining the set of calibration parameters for the model is based on a regression.

12. The method of claim 11, wherein the regression is a gradient descent.

13. The method of claim 11, wherein the regression is an iterative gradient descent.

14. The method of claim 9, wherein the calibration parameters include optical parameters and IMU parameters.

15. The method of claim 14, wherein the optical parameters include an optical center and one or more distortion polynomial coefficients.

16. The method of claim 14, wherein the IMU parameters include a misalignment matrix, a cross-axis sensitivity, and a time delay.

17. A non-transitory computer readable medium configured to store a set of instructions that when executed by a processor cause the processor to:
divide frames into patches;
detect key points on the patches;
compute first local descriptors for the key points on a current frame;
match the first local descriptors of the key points on the current frame to second local descriptors of the key points on a previous frame to obtain matched key points; and
filter the matched key points to obtain a global translation value.

18. The non-transitory computer readable medium of claim 17, wherein the first local descriptors and the second local descriptors are based on a histogram or a gradient.

19. The non-transitory computer readable medium of claim 17, wherein the processor is configured to filter the matched key points using a random sample consensus (RANSAC) algorithm.

20. The non-transitory computer readable medium of claim 17, wherein the processor is configured to detect the key points at different scales.
